(19) United States
(12) Patent Application Publication
(10) Pub. No.: US 2002/0123560 A1
(43) Pub. Date: Sep. 5, 2002

(54) Sizing composition, sized glass fibres as well as their use

(76) Inventors: Raymond Audenaert, Hamme (BE); Joachim Simon, Dusseldorf (DE); Detlev Joachimi, Krefeld (DE); Alexander Karbach, Krefeld (DE); Matthias Bienmuller, Krefeld (DE); Juan Gonzalez-Blanco, Koln (DE)

Correspondence Address: BAYER CORPORATION, PATENT DEPARTMENT, 100 BAYER ROAD, PITTSBURGH, PA, 15205, US

(21) Appl. No.: 09/930,505

(22) Filed: Aug. 15, 2001

(30) Foreign Application Priority Data
Aug. 16, 2000 (DE) 10039750.6

(51) Int. Cl. C08J 3/00

(52) U.S. Cl. 524/588

(57) ABSTRACT

A sizing composition suitable for glass fibers is disclosed. The composition having a pH value between 3 and 10 contains (a) a film forming agent, (b) a silane coupling agent, (c) a water soluble or water-dispersable compound having amino and/or amido groups, and water is suitable for making sized glass fibers for use in reinforced polymer composites.

The properties of composites fabricated from glass fibres and polymers are influenced to a large extent by the interaction between glass fibres and the polymer matrix surrounding the latter. The purpose of the size is to effect the bonding between the glass fibres and matrix polymer and at the same time ensure the fabricability and processability of the glass fibres. Compositions consisting of water, polymeric binders (the so-called film-forming agents), coupling agents, lubricants, antistatics and further auxiliary substances are used as sizes. In general organic, water-dispersible or water-soluble polyvinyl acetate, polyester, polyester epoxide, polyurethane, polyacrylate or polyolefin resins or their mixtures are used as binders.

Generally film-forming agents and coupling agents are chosen so that there is an affinity between the polymer matrix and the film-forming agents and/or coupling agents present on the surface of the glass fibres and a mechanical bonding is thereby produced between the glass fibres and polymer matrix.

It is understandable therefore that the formulations of the sizes have to be optimised to the respective polymer matrix, and that the properties of the composites react sensitively to changes in the size composition.

The hitherto conventionally used process for producing chopped glass fibres, the “chopped strand process”, as is described for example in “The Manufacturing Technology of Continuous Glass Fibres”, Loewenstein, ISBN 0-444-42185-8, is very expensive due to the many intermediate stages, in which the sized glass fibres are wound into cakes, then dried, possibly stored temporarily, and finally uncoiled and chopped. The known “direct chop process” is accordingly used for the economic production of chopped glass fibres, in which the sized glass fibres are not wound onto cakes but instead are chopped immediately after the sizing, as is described for example in “The Manufacturing Technology of Continuous Glass Fibres”, Loewenstein, ISBN 0-444-42185-8. This process is characterised in particular by its cost-effective production. The disadvantage of this process however is that the mechanical reinforcing properties of the glass fibres produced in the direct chop process are, for reasons that were hitherto not understood, around 15-20% lower than those of the glass fibres produced according to the conventional chopped strand process using the same sizing formulations.

The object of the present invention was accordingly to provide glass fibres that have equally good properties, especially mechanical and thermal properties, in the polymer composite irrespective of the process used to produced chopped glass fibres. In particular the properties of the glass fibres in the polymer composite produced by the direct chop process should not be worse than the properties of the glass fibres in the polymer composite produced by the chopped strand process.

This object was surprisingly achieved by the sizing compositions according to the invention, which in addition to film-forming agents, aminosilanes and/or epoxy-silanes and further conventional sizing constituents, also contain water-soluble or water-dispersible polymeric or at least oligomeric compounds containing amino groups and/or amido groups.

The invention accordingly provides sizing compositions for glass fibres having a pH between 3 and 10, comprising

a) 0.1 to 20 wt. %, preferably 4 to 10 wt. % of polyepoxide, polyether, polyolefin, polyvinyl acetate, polyacrylate or polyurethane resins or mixtures thereof as film-forming agents,

b) 0.1 to 10 wt. %, preferably 0.3 to 2 wt. % of organofunctional silanes as coupling agents,

c) 0.1 to 10 wt. %, preferably 0.3 to 2 wt. % of water-soluble or water-dispersible, oligomeric or polymeric compounds with amino and/or amido groups from c1), c2) and/or c3)

c1) reaction product of polyamines of the formula (I) with acrylate compounds of the formula (II)

HN(R¹)-(Z-NH-)ₐR² (I)

wherein

Z denotes C₁-C₁₆-alkylene, C₅-C₁₀-cycloalkylene, arylene or (A-O)_{b}-A where A=C₁-C₁₆-alkylene and b=1 to 100,

R¹ and R² independently of one another denote H, C₁-C₁₈-alkyl or C₅-C₁₀-cycloalkyl and

a is 1 to 10

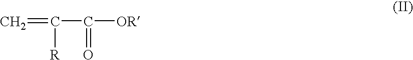

wherein

R denotes H, CH₃

R' denotes C₁-C₆-alkyl, aryl or C₅-C₁₀-cycloalkyl,

c2) compounds of the formula (III)

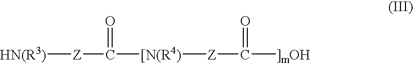

wherein

m is 0 to 50

Z denotes C₁-C₁₆-alkylene, C₅-C₁₀-cycloalkylene, arylene or (A-O)_{b}-A where A=C₁-C₁₆-alkylene and b=1 to 100,

R³ and R⁴ independently of one another denote H, C₁-C₆-alkyl or C₅-C₁₀-cycloalkyl

c3) compounds of the formula (IV)

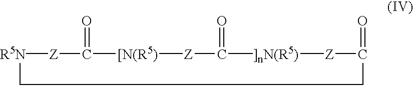

wherein

n is 0 to 10,

Z denotes C₁-C₁₆-alkylene, C₅-C₁₀-cycloalkylene, arylene or (A-O)_{b}-A where A=C₁-C₁₆-alkylene and b=1 to 100,

R⁵ is H, C₁-C6-alkyl or C₅-C₁₀-cycloalkyl,

d) 0 to 10 wt. %, preferably 0.1 to 5 wt. % of further conventional size constituents,

e) 0 to 10 wt. %, preferably 0 to 5 wt. % of additives for adjusting the pH to between 3 and 10, and

f) water as remainder up to 100 wt. %.

The ratio of component b) to component c) is preferably in the range from 10:1 to 0.1:1, particularly preferably 5:1 to 0.5:1, and most particularly preferably 3:1 to 1:1. Very good results are obtained with a ratio of b):c) of 2:1.

The pH value of the size is preferably adjusted to pH 5-9. A pH value of 7 is particularly preferred. The conventional organic or inorganic acids or bases may be used to adjust the pH value.

The production of oligomeric or polymeric amino-amido polymers (see formulae I/II) is described in U.S. Pat. No. 3,445,441. The use in order to improve mechanical properties in glass fibre-polymer composites is not described. The synthesis of these compounds is also described in Dickermann, Simon, J. Org. Chem. (22), (1957), pp. 259-261, as well as in Sanui, Ishida, Ogata, Bull. Chem. Soc. Jpn. (41) (1968), pp. 256-259.

Compounds of the formulae III and IV can be synthesised by the usual processes known for producing oligoamides or polyamides, which are described for example in H. G. Elias, Makromoleküle, 2. Edition, 1972, Hüthig&Wepf, Heidelberg, p. 735 et seq. Suitable processes for producing polyamides as well as their properties are described in Ullmann's Encyclopedia of Industrial Chemistry, 5^{th} Edition, 1992, VCH-Weinheim, Vol. A 21, pp. 179-205 as well as in Encyclopedia of Polymer Science and Engineering, 1988, J. Wiley & Sons, Canada, Volume 21, pp. 315-489.

The invention also provides sized glass fibres that are coated with the dried residue of the sizing compositions according to the invention.

The sized glass fibres according to the invention are used to reinforce thermoplastic and thermosetting polymers.

All known types of glass, such as E-, A-, C- and S-glass used for fibre glass fabrication are suitable for producing the sized glass fibres according to the invention. Among the aforementioned types of glass used for the production of endless glass fibres, the E-glass fibres are, on account of their freedom from alkali, their high tensile strength and their high modulus of elasticity, most important for the reinforcement of plastics materials.

For the sizing of the glass fibres, the latter are provided according to methods known per se with the size according to the invention comprising:

a) 0.1 to 20 wt. %, preferably 4 to 10 wt. % of polyepoxide, polyether, polyolefin, polyvinyl acetate, polyacrylate or polyurethane resins or mixtures thereof as film-forming agents,

b) 0.1 to 10 wt. %, preferably 0.3 to 2 wt. % of organofunctional silanes as coupling agents,

c) 0.1 to 10 wt. %, preferably 0.3 to 2 wt. % of water-soluble or water-dispersible, oligomeric or polymeric compounds with amino and/or amido groups from c1), c2) and/or c3)

c1) reaction product of polyamines of the formula (I) with acrylate compounds of the formula (II)

HN(R¹)-(Z-NH-)ₐR² (I)

wherein

a is 1 to 10

Z denotes C₁_{-C}₁₆-alkylene, C₅-C₁₀-cycloalkylene, arylene or (A-O)_{b}-A where A=C₁-C₁₆-alkylene and b=1 to 100,

R¹ and R² independently of one another denote H, C₁-C₁₈-alkyl or C₅-C₁₀-cycloalkyl

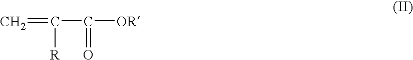

wherein

R denotes H, CH₃

R' denotes C₁-C₆-alkyl, aryl or C₅-C₁-cycloalkyl,

c2) compounds of the formula (III)

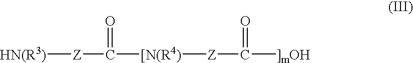

wherein

m is 0 to 50

Z denotes C₁-C₁₆-alkylene, C₅-C₁₀-cycloalkylene, arylene or (A-O)_{b}-A where A=C₁-C₁₆-alkylene and b=1 to 100,

R³ and R⁴ independently of one another denote H, C₁-C₆-alkyl or C₅-C₁₀-cycloalkyl

c3) compounds of the formula (IV)

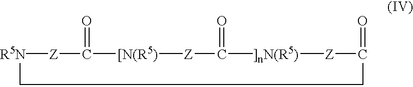

wherein

n is 0 to 10,

Z denotes C₁-C₁₆-alkylene, C₅-C₁₀-cycloalkylene, arylene or (A-O)_{b}-A where A=C₁-C₁₆-alkylene and b=1 to 100,

R⁵ is H, C₁-C₆-alkyl or C₅-C₁₀-cycloalkyl,

d) 0 to 10 wt. %, preferably 0.1 to 5 wt. % of further conventional size constituents,

e) 0 to 10 wt. %, preferably 0 to 5 wt. % of additives for adjusting the pH to between 3 and 10, and

f) water as remainder up to 100 wt. %, and are then chopped and dried.

The size may contain further components such as emulsifiers, further film-forming resins, further coupling agents, lubricants and auxiliary substances such as wetting agents or antistatics.

The further coupling agents, lubricants and other auxiliary substances, processes for the production of the sizes, and processes for the sizing and further processing of the glass fibres are known and are described for example in K. L. Loewenstein “The Manufacturing Technology of Continuous Glass Fibres”, Elsevier Scientific Publishing Corp., Amsterdam, London, New York, 1983.

The glass fibres may be sized by any suitable methods, for example using appropriate devices such as e.g. spray applicators or roller applicators. Sizing compositions can be applied to the glass filaments drawn at high speed from extrusion spinnerets, for example immediately after their solidification, i.e. before they are coiled or chopped. It is however also possible to size the fibres in an immersion bath following the spinning process.

Epoxide resins that have been dispersed, emulsified or dissolved in water are suitable as polyepoxide film-forming agents. Such resins are unmodified epoxide resins or epoxide resins modified by amines, acidic groups or hydrophilic-non-ionic groups, based on diglycidyl ethers of dihydric phenols such as pyrocatechol, resorcinol, hydroquinone, 4,4'-dihydroxydiphenyldimethylmethane (bisphenol A), 4,4'-di-hydroxy-3,3'-dimethyldiphenylpropane, 4,4'-dihydroxydiphenylsulfone, glycidyl esters of dibasic, aromatic, aliphatic and cycloaliphatic carboxylic acids such as for example phthalic anhydride bisglycidyl ether or adipic acid bisglycidyl ether, glycidyl ethers of dihydric aliphatic alcohols such as butanediol bisglycidyl ether, hexanediol bisglycidyl ether or polyoxyalkylene glycol bisglycidyl ether, as well as polyglycidyl ethers of polyhydric phenols, for example of novolaks (reaction products of monohydric or polyhydric phenols with aldehydes, especially formaldehyde, in the presence of acid catalysts), tris-(4-hydroxyphenyl)methane or 1,1,2,2-tetra(4-hydroxyphenyl)ethane, epoxide compounds based on aromatic amines and epichlorohydrin, for example tetraglycidyl methylenedianiline, N-diepoxy-propyl-4-aminophenylglycidyl ether; glycidyl esters of polybasic aromatic, aliphatic and cycloaliphatic carboxylic acids; glycidyl ethers of polyhydric alcohols, for example of glycerol, trimethylolpropane, pentaerithrytol and further glycidyl compounds such as trisglycidyl isocyanurate.

The addition of amines or the addition of hydrophilic polyethers, for example polyethylene glycols, are for example suitable forms of chemical modification. Suitable polyepoxide dispersions are described for example in EP-A 27 942, EP-A 311 894, U.S. Pat. No. 3,249,412, U.S. Pat. No. 3,449,281, U.S. Pat. No. 3,997,306 and U.S. Pat. No. 4,487,797. Preferred are polyester epoxides based on bisphenol A and dispersed, emulsified or dissolved in water, and novolaks. Polyurethane film-forming agents are reaction products dispersed, emulsified or dissolved in water, of preferably difunctional polyisocyanates with preferably dihydric polyols and optionally preferably difunctional polyamines. The synthesis of polyurethane dispersions, starting compounds that can be used, the production processes and their properties are known to the person skilled in the art and are described for example in Houben-Weyl “Methoden der Organischen Chemie”, Vol. E 20, edited by H. Bartl and J. Falbe, Georg Thieme Verlag Stuttgart, New York 1987 on pp. 1587 to 1604, 1659 to 1681, and 1686 to 1689.

Suitable isocyanates are aliphatic, cycloaliphatic, araliphatic, aromatic and hetero-cyclic polyisocyanates or any convenient mixtures of these polyisocyanates, such as for example 1,6-hexamethylene diisocyanate, 1-isocyanato-3,3,5-trimethyl-5-iso-cyanatomethylcyclohexane, 2,4- and 2,6-toluylene diisocyanate, diphenylmethane-2,4'- and/or -4,4'-diisocyanate and 1,6-bis-cyclohexylmethane diisocyanate (Desmodur® W).

Suitable polyols are polyesters, thus for example reaction products of preferably dihydric polyalcohols such as for example ethylene glycol, propylene glycol, butylene glycol and hexanediol, with preferably dibasic polycarboxylic acids or their esterifiable derivatives, such as for example succinic acid, adipic acid, phthalic acid, phthalic anhydride, maleic acid and maleic anhydride. Polyesters of lactones, for example ε-caprolactam, may also be used. Polyesters may also contain portions of trihydric alcohols or carboxylic acid components, such as for example trimethyl-propane or glycerol. Also suitable are branched or unbranched polyethers prepared for example by polymerisation of epoxides such as e.g. ethylene oxide, propylene oxide or tetrahydrofuran, or by addition of the epoxides to starting components with reactive hydrogen atoms, such as water, alcohols, ammonia or amines.

As so-called chain extenders, i.e. preferably dihydric polyols or polyamines having a molecular weight of less than 400, there are particularly preferably used dihydric polyalcohols such as ethylene glycol, propylene glycol, butylene glycol, amino-alcohols such as ethanolamine, N-methyldiethanolamine, as well as difunctional amines and polyamines such as for example ethylenediamine, 1,4-tetramethylene-diamine, hexamethylenediamine, 1-amino-3,3,5-trimethyl-5-amino-methylcyclo-hexane, bis-(3-aminopropyl)methylamine and hydrazine.

Polyurethane dispersion, emulsions or solutions having epoxide groups or capped isocyanate groups are also suitable (see for example EP-A 137 427).

Polyester dispersions are preferably reaction products of the aforementioned poly-epoxides with the aforementioned polycarboxylic acids, or carboxyl group-containing polyesters (see for example EP-A 27 942) that no longer contain epoxide groups.

Suitable organofunctional silanes (b) are for example 3-aminopropyl-trimethoxy-silane, 3-aminopropyltriethoxysilane, 3-aminopropyltrimethoxy-ethoxysilane, 3-aminopropymethyldiethoxysilane, N-2-aminoethyl-3-aminopropyl-trimethoxysilane, N-2-aminoethyl-3-aminopropylmethyldimethoxysilane, N-methyl-3-aminopropyltri-methoxysilane, 3-glycidyloxypropyltrimethoxysilane, 3-meth-acryloxypropyltrimeth-oxysilane, 3-mercaptopropyltrimethoxysilane, vinyl triethoxy-silane and vinyl trimethoxysilane, or oligomeric or polymeric aminofunctional silane compounds, for example oligo-amino-amide silanes such as A1387 from Witco.

Suitable compounds as component c) are amino-amido functional compounds such as for example non-crosslinked, soluble oligoamides or polyamides with free terminal, optionally protonated amino groups that are stable on storage in organic solution and that form stable solutions, suspensions or dispersions in aqueous solvents, such as can be obtained by reacting diamines with dicarbonyl compounds, for example dicarboxylic acids or dicarboxylic acid halides, or also by ring-opening polymerisation of lactams. Such compounds occur to some extent as byproducts in the production of polyamines, for example polyamide-6 and polyamide-6,6. In particular the combination of free amino groups and one or more amide groups imparts outstanding properties to the sizing composition. Particularly preferred in this context are open-chain and cyclic compounds of average molecular weights and having more than one amide group per molecule.

Amino-amido compounds may be obtained for example by ring-opening reaction of lactams such as 2-acetidinone, 2-pyrrolidone, 2-piperidone, ε-caprolactam, 7-heptanelactam, 8-octanelactam, 12-dodecanelactam as well as lactams substituted by ring-opening polymerisation, such as 4,4-dimethyl-2-acetidinone, N-alkyllactams, as well as all isomers of methyl-ε-caprolactam. A summary of suitable methods, monomers and processes for the lactam polymerisation is given for example in Houben-Weyl, Methoden der Organischen Chemie, Vol. E 20 Makromolekulare Stoffe, 4^{th} Edition, 1987, Part Vol. 2, p. 1504 et seq. Particularly preferred are amino-amide compounds that can be obtained by ring-opening reaction of ε-caprolactam.

Suitable compounds as component c) are also amino-amidofunctional compounds that are soluble or can be suspended or dispersed in water, and that can be obtained by reaction of diamino or polyamino compounds with acrylate compounds. As diamino compounds there are preferably used amines of the following type:

NH₂(-Z-NH)ₐ-H

wherein

a is 1 to 10

Z is (CH₂)_{b},-CH(CH₃)-CH₂-, -CH₂-CH(CH₃)-CH₂-,

where b=2 to 12.

Suitable compounds include, inter alia, 1,2-diaminoethane (ethylenediamine), 1,3-diaminopropane, 1,4-diaminobutane, 1,5-diaminopentane, 1,6-diaminohexane (hexamethylenediamine), 1,7-diaminoheptane, 1,8-diaminooctane, 1,9-diaminononane, 1,10-diaminodecane, 1,11-diaminoundecane, 1,12-diaminododecane, 1-methyl-1,2-diaminoethane, 2-methyl-1,3-diaminopropane, 1,2-diaminopropane, 2,2-dimethyl-1,3-propanediamine, 1,2-diamino-2-methylpropane. Ethylenediamine is particularly suitable. Also suitable are the higher functional amines with a>1.

Other compounds that are furthermore preferably suitable include alkylated amino compounds of the following formula:

R¹NH-(Z-NH-)ₐR²

wherein

R¹ and R² independently of one another denote H, C₁-C₁₈-alkyl, cyclohexyl and cyclopentyl

a is 1 to 10

Z is C₁-C₁₆-alkylene, C₅-C₁₀-cycloakylene or arylene.

The particularly preferred type in this context has the structure

R¹NH-(Z-NH-)ₐH

wherein

R¹ is H, C₁-C₁₈-alkyl and

a is 1 to 10 and

Z denotes C₁-C₁₆-alkylene, arylene or C₅-C₁₀-cycloalkylene.

Highly suitable compounds are for example N-methylethylenediamine, N-ethyl-ethylenediamine, N-propylethylenediamine, N-butylethylenediamine, N-pentyl ethylenediamine, N-hexylethylenediamine, N-octylethylenediamine, N,N'-dimethyl ethylenediamine, N,N'-diethylethylenediamine, N,N'-dipropylethylenediamine, N,N'-dibutylethylenediamine, N,N'-diethyl-1,3-propanediamine, 2-butyl-2-ethyl-1,5-pentanediamine, N-(3-aminopropyl)-1,3-propanediamine, N-methyl-1,3-propane-diamine, N-propyl-1,3-propanediamine, N,N'-dimethyl-1,6-hexanediamine, diethyl-enetriamine, N-(2-aminoethyl)-1,3-propanediamine, spermidine, N-isopropyl-1,3-propanediamine, N,N'-dimethyl-1,3-propanediamine, 3,3'-diamino-N-methyldi-propylamine, bis(hexamethylene)-triamine, spermine, N,N'N'-trimethylbis(hexa-methylene)-triamine, N,N'-bis(3-aminopropyl)-ethylenediamine, pentaethylene-hexamine, 4-(aminomethyl)-1,8-octanediamine, N,N'-bis(2-aminoethyl)1,3-propane-diamine, tris(2-aminoethyl)amine, tetraethylenepentamine, 1,3-cyclohexane-bis(methylamine), 1,2-diaminocyclohexane.

Also suitable are amino compounds of the structure

NH₂-(A-O-)_{C}-A-NH₂

wherein

A denotes C₁-C₁₆-alkylene,

c is 1 to 100.

The polyether chains of these compounds preferably consist in an amount of at least up to 80 wt. %, particularly preferably 100 wt. %, of ethylene oxide units, wherein in addition to the latter propylene oxide units may also be present. Preferred compounds include for example polyethylene glycols having molecular weights of 300 to 6,000 (for example Carbowax® 300, 400, 1000, 1500, 2000, 6000 from Union Carbide), difunctional ether diamines such as for example 4,7-dioxadecane-1,10-diamine, 4,9-dioxadodecane-1,12-diamine, 4,7,10-trioxadecane-1,13-diamine, bis-(3-aminopropyl)-polytetrahydrofuran (products known as Carbowax® 750, 1100, 2100 from BASF) as well as polyether amines (for example Jeffamine® D 230, D 400, D 2000, XTJ 510 (D 4000), ED 600, ED 900, ED 2003, ED 4000, EDR 148 (XTJ 504) from Texaco Chemical Company).

Most particularly preferred are the following difunctional ether diamines: 4,7-dioxadecane-1,10-diamine; 4,9-dioxadodcane-1,12-diamine; 4,7,10-trioxadecane-1,13 -diamine; bis-(3-aminopropyl)-polytetrahydroftiran 750, bis-(3-aminopropyl)-polytetrahydrofuran 1 100, bis-(3-aminopropyl)-polytetrahydrofuran 2 100 from BASF and Jeffamine® D 230, D 400, D 2000, XTJ 510 (D 4000), ED 600, ED 900, ED 2003, ED 4000, EDR 148 (XTJ 504) from Texaco Chemical Company).

The sizing compositions may additionally contain further sizing components (d) such as anionic, cationic or non-ionic emulsifiers, further film-forming resins, lubricants such as for example polyalkylene glycol ethers of fatty alcohols or fatty amines, polyalkylene glycol esters and glycerol esters of fatty acids with 12 to 18 C atoms, polyalkylene glycols of higher fatty acid amides with 12 to 18 C atoms of polyalkylene glycols and/or alkenylamines, quaternary nitrogen compounds, for example ethoxylated imidazolinium salts, mineral oils or waxes, and auxiliary substances such as wetting agents or antistatics, for example lithium chloride or ammonium chloride. These further auxiliary substances are known to the person skilled in the art and are described for example in K. L. Loewenstein, “The Manufacturing Technology of Continuous Glass Fibres”, Elsevier Scientific Publishing Corp., Amsterdam, London, New York, 1983.

The glass fibres according to the invention are suitable as reinforcing fibres for thermoplastic polymers, such as for example polycarbonates, polyamide-6 and polyamide-6,6, aliphatic, aromatic and mixed aliphatic/aromatic polyester amides, aliphatic, aromatic and mixed aliphatic/aromatic polyesters such as for example polyethylene terephthalate and polybutylene terephthalate, polyurethanes, poly-arylene sulfides or polycylcoolefins, as well as thermosetting polymers such as unsaturated polyester resins, epoxide resins and phenol-formaldehyde resins.

The invention will be illustrated in more detail with the aid of the following examples.

### EXAMPLE 1

### Preparation of the Component c1)

2.2 moles of ethylenediamine are placed in a reaction vessel at 20° C. while cooling. 4.0 moles of methyl acrylate are then slowly added dropwise at 20° C. while cooling. After stirring for 1 hour at room temperature a further 1.8 moles of ethylenediamine are added dropwise at room temperature. The reaction mixture is heated to 160° C. and the methanol (84.9 g) is distilled off from the top of the column. A residue weighing 411.2 g remains, which is soluble in methanol or water. Analysis of this residue by titration shows 5.86 wt. % of free basic nitrogen in 13.2% of total nitrogen.

### EXAMPLE 2 (COMPARISON)

Production of the Sized Glass Fibres (“Chopped Strand Process”)

The sizing material (composition given in Table 1) was applied to glass fibres of diameter of 14 μm using a cushion-roller applicator. The glass fibres were wound into cakes and then dried for 10 hours at 130° C. After having been dried, the glass fibres were chopped into 4.5 mm long chops (“chopped strand process”).

### EXAMPLE 3 (COMPARISON)

Production of the Sized Glass Fibres (“Direct Chop Process”)

The same sizing material as in Example 2 (see Table 1) was applied using a cushion-roller applicator to the glass fibres of diameter 14 μm. The glass fibres were chopped in the direct chopper immediately after the applicator and were then dried for 10 hours at 130° C. (“direct chop process”).

The glass fibres according to Examples 2 and 3 were extruded in an extruder at an extrusion temperature of 250° C. into a moulding composition consisting of 70 parts by weight of polyamide 6 (Durethan®, commercial product from Bayer AG, Leverkusen) and 30 parts by weight of glass fibres from Example 1 or Example 2, and granulated.

Test pieces and tensile pieces of dimension 80×10×4 mm were produced from the moulding compositions using a conventional injection moulding machine. The flexural strength according to DIN 53452, tensile strength according to DIN 53455 as well as the Izod impact resistance at room temperature (ISO 180/1IC) were tested.

The results are shown in Table 2.

TABLE 1

Amounts in wt. %

| Sizing Components | Example 2 | Example 3 |
|---|---|---|
| Polyurethane dispersion | 4 | 4 |
| Baybond ® PU 0401 | | |
| (Commercial product from Bayer AG) | | |
| 3-aminopropyltriethoxysilane | 1 | 1 |
| Lubricant (polyalkylene glycol) | 0.5 | 0.5 |
| Water | 94.5 | 94.5 |
| Sizing material application | 0.70 | 0.70 |
| (determined by annealing loss) | | |

TABLE 2

| Moulding | | | |
|---|---|---|---|
| composition | Flexural Strength | Tensile Strength | Impact Strength |
| with | in [MPa] | in [MPa] | in [kJ/m²] |
| Glass fibres | 180 | 276 | 56 |
| from Example | | | |
| 2 | | | |
| Glass fibres | 165 | 257 | 46 |
| from Example | | | |
| 3 | | | |

Table 2 shows the lower mechanical property profile of glass fibres from Example 3.

### EXAMPLE 4

The sizing materials consisted of the components according to Table 3 and were applied using a cushion-roller applicator to glass fibres of diameter 11 μm. The glass fibres were then chopped in a direct chopper and finally dried at 130° C.

TABLE 3

| Sizing component | Examples | | | | | |
|---|---|---|---|---|---|---|
| (amount in wt. %) | 4.1 | 4.2 | 4.3 | 4.4 | 4.5 | 4.6 |
| 3-aminopropyltriethoxysilane | 1 | 1 | 1 | 1 | 1 | 1 |
| (A1100, commercial product | | | | | | |
| from Witco, USA) | | | | | | |
| Polyamino-amidosilane | — | 0.5 | — | — | 0.5 | — |
| (A 1387, commercial product | | | | | | |
| from Witco) | | | | | | |
| Compound from Example 1 | — | — | 0.5 | — | — | 0.5 |
| Dispersion from Example 7 | — | — | — | 6 | 6 | 6 |
| Polyurethane dispersion | 4 | 4 | 4 | — | — | — |
| Baybond ® PU 0401, | | | | | | |
| commercial product from | | | | | | |
| Bayer AG) | | | | | | |
| Water | 95 | 94.5 | 94.5 | 93 | 92.5 | 92.5 |
| pH value | pH7 | pH7 | pH7 | pH7 | pH7 | pH7 |

### EXAMPLE 5

70 parts by weight of polyamide 6 (Durethan®, Bayer AG) and 30 parts by weight of glass fibres from Examples 4.1, 4.2 and 4.3 were extruded in an extruder at an extrusion temperature of 250° C. into a moulding composition and granulated. Test specimens and tensile specimens of dimensions 80×10×4 mm were then produced from the moulding compositions in a conventional injection moulding machine. The flexural strength according to DIN 53 452, tensile strength according to DIN 53 455 as well as the Izod impact resistance at room temperature (ISO 180/IC) were tested.

| Moulding | | | |
|---|---|---|---|
| composition | | | |
| with glass | Tensile Strength | Flexural Strength | Impact Strength |
| fibres from | [MPa] | [MPa] | [kJ/m²] |
| Example 4.1 | 165 | 261 | 51 |
| Example 4.2 | 181 | 276 | 61 |
| Example 4.3 | 181 | 276 | 61 |

Example 4.2 and 4.3 show a comparably high mechanical property profile in contrast to Example 4.1

### EXAMPLE 6

70 parts by weight of thermoplastic polyester (Pocan® B1200, Bayer AG) and 30 parts by weight of glass fibres from Examples 4.4, 4.5 and 4.6 were extruded in an extruder at an extrusion temperature of 250° C. into a moulding composition and granulated. Test specimens and tensile specimens of dimensions 80×10×4 mm were then produced from the moulding compositions in a conventional injection moulding machine. The flexural strength according to DIN 53 452, tensile strength according to DIN 53 455 as well as the Izod impact resistance at room temperature (ISO 180/IC) were tested.

| Moulding | | | |
|---|---|---|---|
| composition | | | |
| with glass | Tensile Strength | Flexural Strength | Impact Strength |
| fibres from | [MPa] | [MPa] | [kJ/m²] |
| Example 4.4 | 147 | 228 | 42 |
| Example 4.5 | 155 | 239 | 47 |
| Example 4.6 | 155 | 240 | 47 |

Examples 4.1/4.4 clearly show that the plastics materials reinforced with glass fibres have worse mechanical properties if the glass fibres have been produced by the direct chop process. The reinforced plastics containing glass fibres produced by the chopped strand process (Example 2) have better mechanical properties with the same formulation of the sizing material (see Example 2 compared to Example 3).

Examples 5 and 6 show that plastics materials that have been reinforced with glass fibres produced by the direct chop process have improved mechanical properties if the glass fibres have been sized with the sizing materials according to the invention (see Examples 4.3 and 4.6 in comparison to 4.1 and 4.4).

Contrary to the opinion of those skilled in the art that improved mechanical properties can be obtained when using glass fibres produced by the direct chop process only if oligomeric compounds containing silanol functional groups and that are expensive and very difficult to synthesise are used as sizing constituents, this objective can also be achieved with the-sizing materials according to the invention (see Examples 4.3 and 4.6 in comparison to Examples 4.2 and 4.5). Furthermore, the sizing materials according to the invention are considerably easier to handle. On account of the tendency of the hitherto used oligomeric silanes to crosslink, the sizing materials containing the oligomeric silanes could be handled only in very diluted form and in inert solvents.

### EXAMPLE 7

### Production of a Polyester Dispersion

77.5 g of a polyethylene glycol having a mean molecular weight of 1550 g/mole and 10 g of succinic anhydride are added to a three-necked flask provided with a mechanical stirrer and internal thermometer, heated at 100° C., and stirred until an acid no. of 68 mg KOH/g is obtained. 312.5 g of an epoxidised novolak based on phenol and formaldehyde with an epoxide equivalent weight of 175 g/equivalent and 1 g of sodium carbonate are next added and stirred until an acid no. of 0 is obtained. The ready-for-use epoxide resin has a content of epoxide groups of 0.42 mole per 100 g of resin and an average functionality of ca. 3.0 epoxide groups per molecule. The temperature in the reaction flask is reduced to 60° C. and 600 ml of warm water of temperature ca. 70° C. are added in portions of ca. 100 ml.

A white, homogeneous, finely particulate and storage-stable dispersion with a viscosity of ca. 20 mPa.s is formed.

1. Sizing composition for glass fibres with a pH value between 3 and 10, comprising:
a) 0.1 to 20 wt. % of polyepoxide, polyether, polyolefin, polyvinyl acetate, polyacrylate or polyurethane resins or mixtures thereof as film-forming agents,
b) 0.1 to 10 wt. % organofunctional silanes as coupling agents,
c) 0.1 to 10 wt. % of water-soluble or water-dispersible, oligomeric or polymeric compounds with amino and/or amido groups from c1), c2) and/or c3)
c1) reaction product of polyamines of the formula (I) with acrylate compounds of the formula (II)
HN(R¹)-(Z-NH-)ₐR² (I)
wherein
Z denotes C₁-C₁₆-alkylene, C₅-C₁₀-cycloalkylene, arylene or (A-O)_{b}-A where A=C₁-C₁₆-alkylene and b=1 to 100,
R¹ and R² independently of one another denote H, C₁-C₁₈-alkyl or C₅-C₁₀-cycloalkyl and
a is 1 to 10 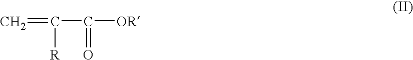
wherein
R denotes H, CH₃
R' denotes C₁-C₆-alkyl, aryl or C₅-C₁₀-cycloalkyl,
c2) compounds of the formula (III) 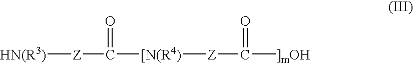
wherein
m is 0 to 50
Z denotes C₁-C₁₆-alkylene, C₅-C₁₀-cycloalkylene, arylene or (A-O)_{b}-A where A=C₁-C₁₆-alkylene and b=1 to 100,
R³ and R⁴ independently of one another denote H, C₁-C₆-alkyl or C₅-C₁₀-cycloalkyl
c3) compounds of the formula (IV) 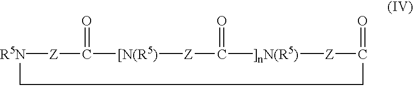
wherein
n is 0 to 10,
Z denotes C₁-C₁₆-alkylene, C₅-C₁₀-cycloalkylene arylene or (A-O)_{b}-A where A=C₁-C₁₆-alkylene and b=1 to 100,
R⁵ is H, C₁-C₆-alkyl or C₅-C₁₀-cycloalkyl,
d) 0 to 10 wt. %, preferably 0.1 to 5 wt. % of further conventional size constituents,
e) 0 to 10 wt. %, preferably 0 to 5 wt. % of additives for adjusting the pH to between 3 and 10, and
f) water as remainder up to 100 wt. %.

2. Sizing composition according to claim 1 characterized in that the ratio of component b) to component c) is in the range from 10:1 to 0.1:1.

3. The sizing composition of claim 1 wherein pH of the composition is between 5 and 9.

4. The sizing composition of claim 6 wherein pH of the composition is 7.

5. Sized glass fibers comprising the sizing composition of claim 1.

6. A method of using the glass fibers of claim 8 comprising making reinforced polymers.
